(19) United States
(12) Patent Application Publication
(10) Pub. No.: US 2024/0340281 A1
(43) Pub. Date: Oct. 10, 2024

(54) TECHNOLOGIES FOR QUASI-CENTRALIZED, SECURE BIOMETRIC DATA MANAGEMENT

(71) Applicant: Joshua van Asakinda, Negley, OH (US)

(72) Inventor: Joshua van Asakinda, Negley, OH (US)

(21) Appl. No.: 18/618,228

(22) Filed: Mar. 27, 2024

Related U.S. Application Data
(60) Provisional application No. 63/456,939, filed on Apr. 4, 2023.

(51) Int. Cl. H04L 9/40

(52) U.S. Cl. CPC H04L 63/0861

(57) ABSTRACT

Technologies for secure biometric data management include a cloud server in communication with multiple user devices and third-party devices. The cloud server verifies a user's identity, receives captured biometric data indicative of multiple biometric marker scans associated with the user, generates a biomatrix as a function of the captured biometric data, and associates secure data storage with the stored biomatrix. The cloud server receives biomatrix data from a client computing device such as a user device or a third-party device, determines a set of biometric markers, and verifies the received biometric data using the set of biometric markers. The cloud server allows access to the secure data storage in response to verifying the biomatrix data. Other embodiments are described and claimed.

### CROSS-REFERENCE TO RELATED APPLICATION

This application claims priority to U.S. Provisional Application Ser. No. 63/456,939, filed Apr. 4, 2023, the entire disclosure of which is hereby incorporated by reference.

### BACKGROUND

Increasingly, official records and other important documents and data are stored online. Typical systems use a combination of username and password to secure access to online data. However, usernames and passwords—and particularly lengthy, complicated passwords that are more secure—are difficult to use and are often forgotten by users. Typical solutions to improve online security include physical security keys and password managers.

### SUMMARY

According to one aspect of the disclosure, a computing device for secure biometric data management comprises a portal manager and a storehouse manager. The portal manager is to receive a biomatrix from a client computing device. The biomatrix comprises data indicative of one or more biometric marker scans associated with a user. The portal manager is further to determine a set of biometric markers from the one or more biometric marker scans, and verify the biomatrix using the set of biometric markers based on a stored biomatrix. The storehouse manager is to access secure data storage associated with the user in response to verifying the biomatrix. In an embodiment, the client computing device comprises a user device or a third-party device.

In an embodiment, to determine the set of biometric markers comprises to select a random set of the one or more biomarker scans. In an embodiment, to determine the set of biometric markers comprises to select the set of biometric markers based on a predetermined security policy. In an embodiment, to determine the set of biometric markers comprises to determine a number of biometric markers in the set of biometric markers based on a predetermined security policy. In an embodiment, the one or more biometric marker scans comprises a facial recognition scan, a first retina scan, a second retina scan, a first fingerprint scan, and a second fingerprint scan.

In an embodiment, the portal manager is further to receive user authorization for access by the client computing device, and to access the secure data storage comprises to access the secure data storage in response to receipt of the user authorization. In an embodiment, to access the secure data storage comprises to securely store a document in the secure data storage. In an embodiment, to access the secure data storage comprises to generate an authenticated offline copy of a secure document in the secure data storage, wherein the authenticated offline copy comprises a digital watermark indicative of authenticity. In an embodiment, to access the secure data storage comprises to authorize transfer of a secure document in the secure data storage to a third party.

In an embodiment, the portal manager is further to identify the user based on the biomatrix. In an embodiment, to access the secure data storage comprises to access a user identity associated with the user. In an embodiment, the secure data storage comprises personal documents, legal documents, or health records associated with the user.

In an embodiment, the computing device further comprises a biomatrix manager to verify an identity of the user, receive captured biometric data indicative of the one or more biometric marker scans associated with the user, generate the stored biomatrix as a function of the captured biometric data in response to verification of the identity of the user, and associate the secure data storage with the stored biomatrix.

According to another aspect, a method for secure biometric data management comprises receiving, by a computing device, a biomatrix from a client computing device, wherein the biomatrix comprises data indicative of one or more biometric marker scans associated with a user; determining, by the computing device, a set of biometric markers from the one or more biometric marker scans; verifying, by the computing device, the biomatrix using the set of biometric markers based on a stored biomatrix; and accessing, by the computing device, secure data storage associated with the user in response to verifying the biomatrix. In an embodiment, the client computing device comprises a user device or a third-party device.

In an embodiment, determining the set of biometric markers comprises selecting a random set of the one or more biomarker scans. In an embodiment, determining the set of biometric markers comprises selecting the set of biometric markers based on a predetermined security policy. In an embodiment, determining the set of biometric markers comprises determining a number of biometric markers in the set of biometric markers based on a predetermined security policy. In an embodiment, the one or more biometric marker scans comprises a facial recognition scan, a first retina scan, a second retina scan, a first fingerprint scan, and a second fingerprint scan.

In an embodiment, the method further comprises receiving, by the computing device, user authorization for access by the client computing device; wherein accessing the secure data storage comprises accessing the secure data storage in response to receiving the user authorization. In an embodiment, accessing the secure data storage comprises securely storing a document in the secure data storage. In an embodiment, accessing the secure data storage comprises generating an authenticated offline copy of a secure document in the secure data storage, wherein the authenticated offline copy comprises a digital watermark indicative of authenticity. In an embodiment, accessing the secure data storage comprises authorizing transfer of a secure document in the secure data storage to a third party. In an embodiment, the secure data storage comprises personal documents, legal documents, or health records associated with the user.

In an embodiment, the method further comprises identifying, by the computing device, the user based on the biomatrix. In an embodiment, accessing the secure data storage comprises accessing a user identity associated with the user.

In an embodiment, the method further comprises verifying, by the computing device, an identity of the user; receiving, by the computing device, captured biometric data indicative of the one or more biometric marker scans associated with the user; generating, by the computing device, the stored biomatrix as a function of the captured biometric data in response to verifying the identity of the user; and associating, by the computing device, the secure data storage with the stored biomatrix.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for quasi-centralized, secure biometric data management;

FIG. 2 is a simplified block diagram of an environment that may be established by a cloud server of FIG. 1;

FIG. 3 is a simplified flow diagram of at least one embodiment of a method for biomatrix generation that may be executed by the cloud server of FIGS. 1 and 2;

FIG. 4 is a simplified flow diagram of at least one embodiment of a method for user interface portal management that may be executed by the cloud server of FIGS. 1 and 2;

FIG. 5 is a simplified flow diagram of at least one embodiment of a method for a third-party nexus portal that may be executed by a ticket server of FIGS. 1 and 2; and

FIG. 6 is a schematic diagram illustrating the system of FIGS. 1-2 and the methods of FIGS. 3-5.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

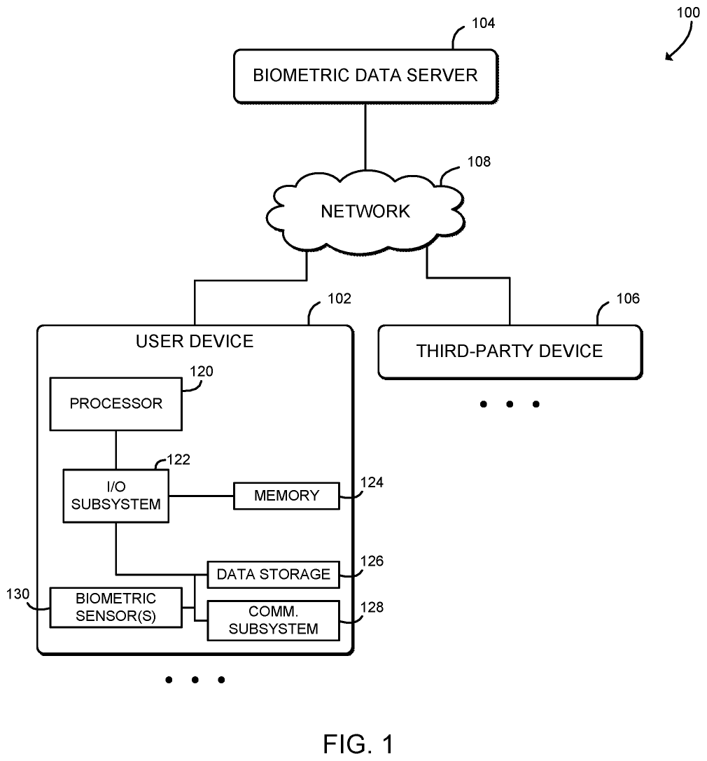

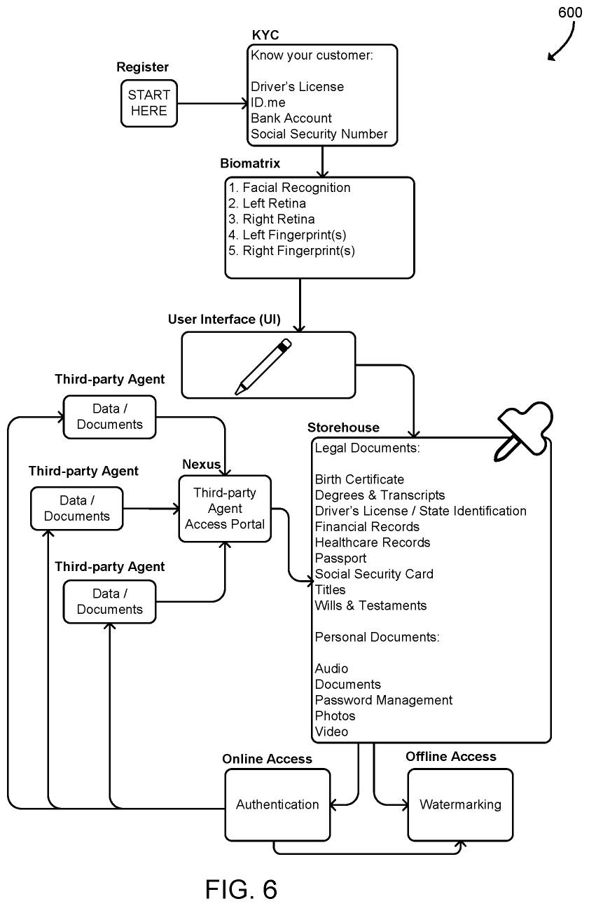

Referring now to FIG. 1, an illustrative system 100 for quasi-centralized, secure biometric data management includes one or more user devices 102, a cloud server 104, and one or more third-party devices 106 in communication over a network 108. Referring to FIG. 6, diagram 600 illustrates one potential embodiment of the system 100.

The system 100 is a quasi-centralized storehouse of data and documents protected by biometric encryption that renders usernames and passwords entirely obsolete. In particular, the system 100 creates a central storehouse for an individual's online identity, protected securely behind a fully biometric encryption system. When a user logs on to the system 100, the user does not “access an account;” rather, the user scans a randomized (and customizable) selection of biometric markers referred to as a biomatrix. This biomatrix serves as both the username and the password for their account—that is, it serves as both the public key and the private key for their online identity, which includes a nexus for third party integration and an online/offline storehouse of critical data and documents. Once these have been created, they can access watermarked—that is, fully authenticated copies of—documentation for all aspects of their lives from licenses to degrees to passports to healthcare documents. Additionally, because of this novel method of access, the system 100 could be integrated into other systems in a device-agnostic fashion: Rather than attaching access to a particular device (for instance, being able to log in on one's own cell phone but not being able to log in on someone else's cell phone), the system 100 could allow users to access the online (but not the offline) aspect of their storehouse on other, secured devices integrated into the system 100 ecosystem, such as doctor's offices, high-security government buildings, or international ports of entry. The system 100 prevents loss; it makes hacking nearly impossible; it makes document storage a thing of the past; stated simply, the system 100 is the next generation of security and identity verification.

The system 100 centralizes critical data and documents around an individual's biomatrix, which is a collection of biometric markers that serves as the user's digital identity. This encrypted biomatrix serves not only as an identity, but is synonymous with a username and password. Because of this, the system 100 makes it nearly impossible to steal, lose, or hack user accounts or the information secured behind those user accounts. Accordingly, this revolutionizes not only online security, but also revolutionizes the very definition of a digital identity. For example, by replacing username and password or other traditional credentials with the biomatrix derived from biometrics, the system 100 makes it virtually impossible for a user to lose access to user accounts and/or information secured behind those user accounts.

The system 100 creates a nexus for integration for third-party agents that makes it possible to hold fully authenticated copies of documents. These authenticated copies of documents are accessible through an application of the system 100, and could be downloaded to the application itself for offline use. Presentation of documents via the system 100 is made possible via fully authenticated digital copies, which may be even more counterfeit-resistant than the original, physical source documents. Watermarking allows the system 100 to embed authentication code into the document that cryptographically ensures its authenticity and data pertaining to its source, time, and date of access.

The system 100 enables users to have instant access—either online or offline—to critical documents through the storehouse, which serves as a digital library of critical data and documents. This digital library may include password management functionality. Rather than holding data and documents across an indefinite number of filing systems both digital and physical, the system 100 makes it possible to centralize critical information in a manner that would allow it to be instantly accessible—not to mention transferable—at all times. Accordingly, the system 100's storehouse may render traditional data and document storage obsolete.

The system 100 enables users to have offline access to data and documents held in the users' storehouse, the source and authenticity of which would be verifiable by encrypted watermarking. This watermarking helps to make offline copies of data and documents fully authenticated; this in turn would make data and document transmission faster and more secure. Many applications of this are possible: For instance, the system 100 may be used to transfer data and documents such as titles or healthcare records without the need of an intermediary to verify their source and authenticity. Instead, one could merely transfer the data and documents via a third-party agent application integrated with the system 100.

The system 100 enables nearly limitless applications, ranging from identification to security to healthcare and everything in between. Virtually any website or application that has security and that utilizes a username and password could use the system 100. Furthermore, the system 100 streamlines document collection and document preservation, as storehouses serve effectively as individualized and quasicentralized document warehouses. The system 100 enables multiple applications, several of which, without limitation, are described herein.

The system 100 allows a person to access their cell phone, bank account, even their work computer without having to be concerned about losing access to an associated email address. If access to their email address is lost, the person would still have access to any application integrated into the system 100 either natively or via extension. Because the individual's biometrics are both the public key and the private key, no email address is necessary for storehouse creation.

The system 100 makes traditional storage and verification of documents a thing of the past. Not only could documents held by third-party agents be accessed via the system 100 (for example, college transcripts), but first-party user documents could be stored on the system 100 as well and transferred with full authentication, which would make documents shared through the system 100 ecosystem de facto legally binding.

The system 100 streamlines the security process in numerous ways, as there is virtually no risk of one person illegally accessing the account of another. This streamlined security process will create numerous improvements, for example in the realm of government identification, as licenses, passports, IRS records, legal documents, would all be almost by default immune to fraud. Anything requiring identification would be impossible to hack, impossible to fake, and impossible to forge, since doing this would require the de-encryption of not one but multiple biometric markers.

The system 100 makes identification as simple as opening up an application. States could integrate their driver's licenses with the system 100; governments could integrate their passports with the system 100. Nobody would ever lose their license again, or have their identity stolen, or get stranded overseas because their passport was stolen while on vacation. All of these could be accessed at any time in any place on any device in the world with access to the system 100 ecosystem—for example, a cell phone, a desktop computer-, including DMVs, banks, customs, and other ports of entry.

The system 100 vastly simplifies the transference of critical documents such as healthcare records, which are protected under HIPAA. With the system 100, a patient could enter a new doctor's office, scan their biometrics at their computer terminal, and instantly have access to all of their own medical records, and immediately transfer access to those records to their new doctor with a few swipes of their finger. This would reduce lag time in healthcare by orders of magnitude, not to mention that it would make securely storing those documents safer, more secure, and vastly more efficient. Currently, every healthcare record created post-HIPAA must be stored in physical form somewhere. The system 100 may allow healthcare records to be stored securely and thus physical storage may no longer be required.

As shown in FIG. 6, a user may register by going through an enhanced “Know Your Customer” (KYC) process, which includes identity verification through some combination of driver's license or other state identification, ID.me, bank account, and social security number. Then, once the authenticity of their identity has been established, the user scans multiple biometric marks in order to create their own, unique biomatrix; the number of biometric markers required for login is customizable for users with higher-level security needs. Through the user interface (UI), users have access to their storehouse; users also have options to attach their account to an email address in order to export documents or to enable two-factor authentication via physical security key. This UI is connected to the nexus, which is the third-party agent access portal through which third-party organizations (e.g., organizations outside of the system 100) may integrate with the system 100. The nexus is not accessible by the user, of course, but security measures ensure that the user alone determines which third-party agents are permitted to integrate with the system 100 (if any, as the system 100 may be used for private document storage by itself). If the user has online access, the user will be able to access integrated third-party agent databases through their UI, or download watermarked, fully authenticated copies of those documents for offline access. The system 100 may include QR code scanning functionality for third-party agents such as healthcare offices or law enforcement organizations.

Accordingly, the system 100 may revolutionize the way that digital identities are created, applied, and maintained; how they interact with one another; and the degree to which they are safe, secure, and resilient to loss and fraud. Compared to typical solutions such as usernames and passwords, password managers, and/or physical security keys, loss of access will become a thing of the past. Furthermore, the system 100 biomatrix will make hacking exceedingly difficult, if not practically impossible; because the system 100 uses a multiplicity of biometrics in order to create the biomatrix, multiple biometrics would have to be hacked in order to access the system by a bad actor. (Of course, as with any cryptographic system, the system 100 may be vulnerable to hacking through unauthorized access to secret material such as derived private keys.) Further, the transference of data and documents would be made far more efficient as compared to typical systems.

Referring again to FIG. 1, each user device 102 may be embodied as any type of device capable of performing the functions described herein. For example, the user device 102 may be embodied as, without limitation, a smartphone, a tablet computer, a consumer electronic device, a desktop computer, a laptop computer, a network appliance, a web appliance, a distributed computing system, a multiprocessor system, and/or any other computing device capable of performing the functions described herein. As shown in FIG. 1, the illustrative user device 102 includes a processor 120, an I/O subsystem 122, memory 124, a data storage device 126, and communication circuitry 128. Of course, the user device 102 may include other or additional components, such as those commonly found in a smartphone (e.g., various input/output devices), in other embodiments. Additionally, in some embodiments, one or more of the illustrative components may be incorporated in, or otherwise form a portion of, another component. For example, the memory 124, or portions thereof, may be incorporated in the processor 120 in some embodiments.

The processor 120 may be embodied as any type of processor or compute engine capable of performing the functions described herein. For example, the processor may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the user device 102 such as operating systems, applications, programs, libraries, and drivers. The memory 124 is communicatively coupled to the processor 120 via the I/O subsystem 122, which may be embodied as circuitry and/or components to facilitate input/output operations with the processor 120, the memory 124, and other components of the user device 102. For example, the I/O subsystem 122 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with the processor 120, the memory 124, and other components of the user device 102, on a single integrated circuit chip.

The data storage device 126 may be embodied as any type of device or devices configured for short-term or long-term storage of data such as, for example, memory devices and circuits, memory cards, hard disk drives, solid-state drives, or other data storage devices. The communication circuitry 128 of the user device 102 may be embodied as any communication circuit, device, or collection thereof, capable of enabling communications between the user device 102, the third-party device 106, the cloud server 104, and/or other remote devices. The communication circuitry 128 may be configured to use any one or more communication technology (e.g., wireless or wired communications) and associated protocols (e.g., Ethernet, Bluetooth®, Wi-Fi®, WiMAX, etc.) to effect such communication.

As shown, the user device 102 further includes or is otherwise coupled to one or more biometric sensors 130. The biometric sensors 136 may include any number of biometric authentication devices such as an iris scanner/camera, a facial recognition camera, a fingerprint reader, and/or other biometric authentication devices. Additionally or alternatively, in some embodiments the user device 102 may include any number of additional input/output devices, interface devices, and/or other peripheral devices, such as a display, touch screen, graphics circuitry, keyboard, mouse, camera, speaker system, microphone, network interface, motion sensor, proximity sensor, and/or other input/output devices, interface devices, and/or peripheral devices.

The cloud server 104 is configured to manage biomatrixes and secure data storehouses for multiple users, to provide user interface and third-party nexus portals, and to otherwise perform the functions described herein. Accordingly, the cloud server 104 may be embodied as any type of computation or computer device capable of performing the functions described herein, including, without limitation, a server, a rack-mounted server, a blade server, a network appliance, a web appliance, a distributed computing system, a desktop computer, a laptop computer, a notebook computer, a tablet computer, a mobile computing device, a wearable computing device, a multiprocessor system, a processor-based system, and/or a consumer electronic device. Thus, the cloud server 104 includes components and devices commonly found in a server or similar computing device, such as a processor, an I/O subsystem, a memory, a data storage device, and/or communication circuitry. Those individual components of the cloud server 104 may be similar to the corresponding components of the user device 102, the description of which is applicable to the corresponding components of the cloud server 104 and is not repeated herein so as not to obscure the present disclosure. Additionally, in some embodiments, the cloud server 104 may be embodied as a “virtual server” formed from multiple computing devices distributed across the network 108 and operating in a public or private cloud. Accordingly, although the cloud server 104 is illustrated in FIG. 1 as embodied as a single computing device, it should be appreciated that the cloud server 104 may be embodied as multiple devices cooperating together to facilitate the functionality described below.

Each third-party device 106 is configured to access a third-party nexus portal provided by the cloud server 104 and otherwise perform the functions described herein. Accordingly, each third-party device 106 may be embodied as any type of computation or computer device capable of performing the functions described herein, including, without limitation, a smartphone, a tablet computer, a consumer electronic device, a point of sale device, a desktop computer, a laptop computer, a network appliance, a web appliance, a distributed computing system, and/or a multiprocessor system. Thus, the third-party device 106 includes components and devices commonly found in a smartphone or similar computing device, such as a processor, an I/O subsystem, a memory, a data storage device, communication circuitry, and/or various I/O devices. Those individual components of the third-party device 106 may be similar to the corresponding components of the user device 102, the description of which is applicable to the corresponding components of the third-party device 106 and is not repeated herein so as not to obscure the present disclosure.

As discussed in more detail below, the user device 102, the cloud server 104, and the third-party device may be configured to transmit and receive data with each other and/or other devices of the system 100 over the network 108. The network 108 may be embodied as any number of various wired and/or wireless networks. For example, the network 108 may be embodied as, or otherwise include, a wired or wireless local area network (LAN), a wired or wireless wide area network (WAN), and/or a publicly-accessible, global network such as the Internet. As such, the network 108 may include any number of additional devices, such as additional computers, routers, and switches, to facilitate communications among the devices of the system 100.

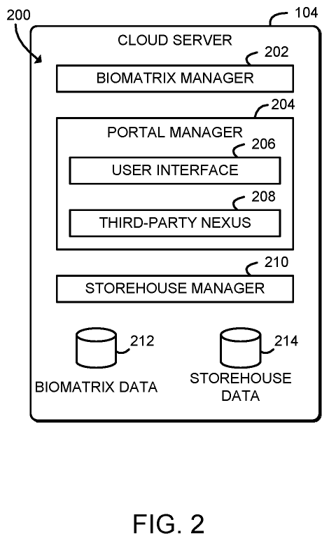

Referring now to FIG. 2, in the illustrative embodiment, the cloud server 104 establishes an environment 200 during operation. The illustrative environment 200 includes a biomatrix manager 202, a portal manager 204, and a storehouse manager 210. The various components of the environment 200 may be embodied as hardware, firmware, software, or a combination thereof. As such, in some embodiments, one or more of the components of the environment 200 may be embodied as circuitry or a collection of electrical devices (e.g., biomatrix manager circuitry 202, portal manager circuitry 204, and/or storehouse manager circuitry 210). It should be appreciated that, in such embodiments, one or more of those components may form a portion of the processor, the I/O subsystem, and/or other components of the cloud server 104.

The biomatrix manager 202 is configured to verify an identity of a user, receive captured biometric data indicative of one or more biometric marker scans associated with the user, and generate stored biomatrix data 212 as a function of the captured biometric data in response to verification of the identity of the user. The biomatrix manager 202 is further configured to associate secure data storage with the stored biomatrix 212. The secure data storage may be embodied as storehouse data 214, and may comprise personal documents, legal documents, or health records associated with the user.

The portal manager 204 is configured to receive a biomatrix from a client computing device such as a user device 102 and/or a third-party device 106. The biomatrix comprises data indicative of one or more biometric marker scans associated with a user. The portal manager 204 is further configured to determine a set of biometric markers from the one or more biometric marker scans, and verify the biomatrix using the first set of biometric markers based on a stored biomatrix 212. In some embodiments, determining the set of biometric markers may include selecting a random set of the one or more biomarker scans. In some embodiments, determining the set of biometric markers may include selecting the first set of biometric markers or selecting a number of biometric markers in the first set of biometric markers based on a predetermined security policy. In some embodiments, the one or more biometric marker scans may include a facial recognition scan, a first retina scan, a second retina scan, a first fingerprint scan, and a second fingerprint scan. In some embodiments, the portal manager 204 is further configured to receive user authorization for access by the client computing device. In some embodiments, the portal manager 204 is further configured to identify the user based on the biomatrix. In some embodiments, those functions may be performed by one or more sub-components, such as a user interface 206 and/or a third-party nexus 208.

The storehouse manager 210 is configured to access secure data storage associated with the user in response to verifying the biomatrix. The secure data storage may be accessed after receiving the user authorization. In some embodiments, accessing the secure data storage may include securely storing a document in the secure data storage, generating an authenticated offline copy of a secure document in the secure data storage, wherein the authenticated offline copy comprises a digital watermark indicative of authenticity, authorizing transfer of a secure document in the secure data storage to a third party, or accessing a user identity associated with the user.

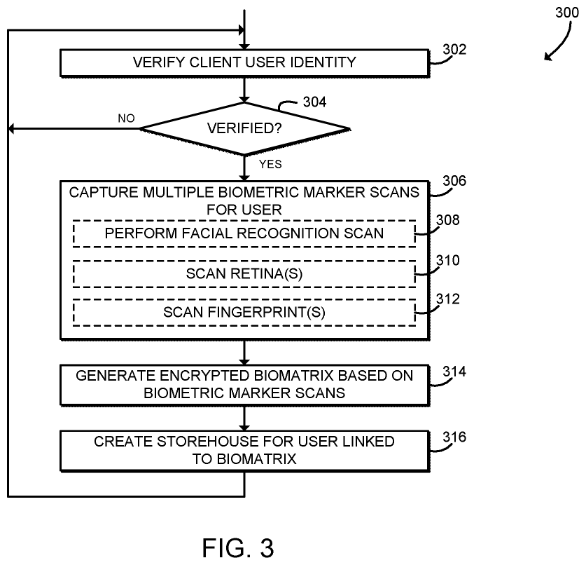

Referring now to FIG. 3, in use, the cloud server 104 may execute a method 300 for biomatrix generation. It should be appreciated that, in some embodiments, the operations of the method 300 may be performed by one or more components of the environment 200 of the cloud server 104 as shown in FIG. 2. The method 300 begins with block 302, in which the cloud server 104 verifies a client user identity. The cloud server 104 may, for example, perform an enhanced “know your customer” process to verify the identity of a user. The cloud server 104 may verify identity using, for example, a driver's license, an online verification service such as ID.me, a bank account, a social security number, or other identifying information. The cloud server 104 may verify the identity of a user operating a user device 102. In block 304, the cloud server 104 determines whether the user was successfully verified. If not, the method 300 loops back to block 302 in which additional verification may be performed. If the user is successfully verified, the method 300 proceeds to block 306.

In block 306, the cloud server 104 captures multiple biometric marker scans for the user. The cloud server 104 may, for example, receive biometric data and/or encrypted data based on the biometric data from a user device 102. The user device 102 may capture the biometric data using one or more biometric sensors 130. The cloud server 104 may capture any number and/or type of biometric data, and the number and/or types of biometric data captured may be determined by one or more security policies. In some embodiments, in block 308 the cloud server 104 may capture facial recognition scan data. In some embodiments, in block 310, the cloud server 104 may capture data from one or more retina scans (e.g., left retina and/or right retina). In some embodiments, in block 312, the cloud server 104 may capture data from one or more fingerprint scans (e.g., left thumb, right thumb, and/or other fingers).

In block 314, the cloud server 104 generates an encrypted biomatrix based on the biometric marker scans. Accordingly, the biomatrix is based on several different biometric marker scans associated with a user. For example, in an illustrative embodiment, the biomatrix is based on five biometric markers: facial scan, left retina, right retina, left thumb, and right thumb.

In block 316, the cloud server 104 creates a storehouse for the user linked to the biomatrix. The storehouse is secure data storage for documents and data associated with the user. The data may be supplied by third parties (e.g., government organizations, healthcare providers, or other organizations) and/or by the user (e.g., personal documents, audio, photos, video, password management, etc.). The storehouse is securely accessed using the biomatrix, which acts as public and private key for the storehouse. After creating the store house, the method 300 loops back to block 302 in which additional client user identities may be verified.

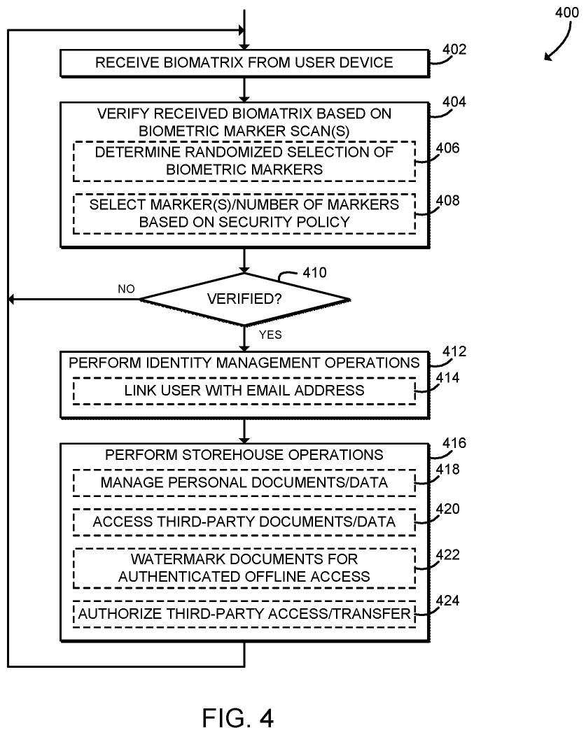

Referring now to FIG. 4, in use, the cloud server 104 may execute a method 400 for user interface portal management. It should be appreciated that, in some embodiments, the operations of the method 400 may be performed by one or more components of the environment 200 of the cloud server 104 as shown in FIG. 2. The method 400 begins with block 402, in which the cloud server 104 receives biomatrix data from a user device 102. As described above, the biomatrix data is indicative of one or more biometric marker scans, and may be captured by the user device 102 using the biometric sensors 130.

In block 404 the cloud server 104 verifies the received biomatrix data based on one or more biometric marker scans. The cloud server 104 may, for example, compare the received biomatrix data to biomatrix data or other biometric templates that were previously stored or otherwise processed as described above in connection with FIG. 3. The cloud server 104 may verify some or all of the biometric markers that were originally captured during generation of the biomatrix. In block 406, the cloud server 104 may determine a randomized selection of biometric markers. For example, the cloud server 104 may randomly select two biomarkers from the five biometric markers that were originally used to generate the biomatrix. The cloud server 104 may request those selected biometric markers from the user device 102, for example by sending a challenge message. Additionally or alternatively, the cloud server 104 may not identify the selected biometric markers to the client device 102 and may select the biometric markers from those received from the client device 102. In some embodiments, in block 408 the cloud server 104 may select the biometric marker(s) and/or the number of biometric markers based on one or more predetermined security policies. For example, a particular security policy may specify that at least three biometric markers must be verified. Of course, any other number or other security policy may be enforced. In block 410, the cloud server 104 verifies whether the received biomarker data was verified. If not, the method 400 loops back to block 402, in which the cloud server 104 may process additional biomatrix requests. If the biomatrix was verified, the method 400 proceeds to block 412.

In block 412, the cloud server 104 may perform one or more identity management operations for the user. In some embodiments, in block 414 the cloud server 104 may link the user with a particular email address or other external address, which may be used to export documents. In some embodiments, the cloud server 104 may link the user with a security key or other multifactor authentication system.

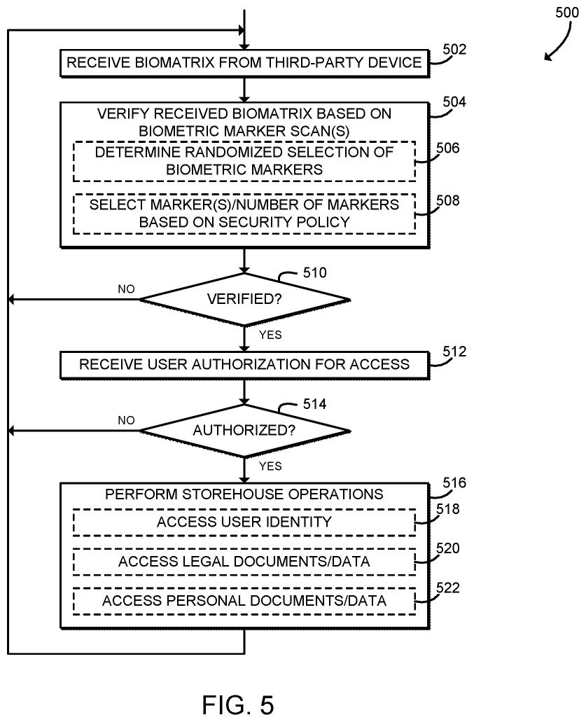

In block 416, the cloud server 104 may perform one or more storehouse operations. The cloud server 104 may allow access (e.g., read, write, modify, or other access) to secure data storage in the storehouse associated with the biometrically verified user. In some embodiments, in block 418 the cloud server 104 may manage personal documents and/or data. In some embodiments, in block 420 the cloud server 104 may manage third-party documents and/or data. The third-party documents and/or data may be stored or otherwise originate from the third-party nexus as described further below in connection with FIG. 5. In some embodiments, in block 422 the cloud server 104 may watermark one or more documents for authenticated offline access. For example, the cloud server 104 may embed a digital watermark into the document, such as authentication code that cryptographically ensures authenticity of the document and/or metadata related to the document's source, time, and date of access. In some embodiments, in block 424 the cloud server 104 may authorize third-party access and/or transfer for documents and/or data. For example, the user may specify that certain third parties are permitted and/or prohibited from accessing certain documents and/or data maintained in the storehouse. After performing storehouse operations, the method 400 loops back to block 402, in which the cloud server 104 may process additional biomatrix requests.

Referring now to FIG. 5, in use, the cloud server 104 may execute a method 500 for user interface portal management. It should be appreciated that, in some embodiments, the operations of the method 500 may be performed by one or more components of the environment 200 of the cloud server 104 as shown in FIG. 2. The method 500 begins with block 502, in which the cloud server 104 receives biomatrix data from a third-party device 106. As described above, the biomatrix data is indicative of one or more biometric marker scans, and may be captured by the third-party device 106 using biometric sensors (e.g., similar to the biometric sensors 130 of a user device 102). For example, in an illustrative embodiment, a user may operate a third party device 106 at a trusted organization such as a doctor's office. As another example, a user may operate an untrusted third party device 106 such as a public computer or kiosk or a borrowed mobile device.

In block 504 the cloud server 104 verifies the received biomatrix data based on one or more biometric marker scans. The cloud server 104 may, for example, compare the received biomatrix data to biomatrix data or other biometric templates that were previously stored or otherwise processed as described above in connection with FIG. 3. The cloud server 104 may verify some or all of the biometric markers that were originally captured during generation of the biomatrix. In block 506, the cloud server 104 may determine a randomized selection of biometric markers. For example, the cloud server 104 may randomly select two biomarkers from the five biometric markers that were originally used to generate the biomatrix. The cloud server 104 may request those selected biometric markers from the third-party device 106, for example by sending a challenge message. Additionally or alternatively, the cloud server 104 may not identify the selected biometric markers to the third-party device 106 and may select the biometric markers from those received from the third-party device 106. In some embodiments, in block 508 the cloud server 104 may select the biometric marker(s) and/or the number of biometric markers based on one or more predetermined security policies. For example, a particular security policy may specify that at least three biometric markers must be verified. Of course, any other number or other security policy may be enforced. In block 510, the cloud server 104 verifies whether the received biomarker data was verified. If not, the method 500 loops back to block 502, in which the cloud server 104 may process additional biomatrix requests. If the biomatrix was verified, the method 500 proceeds to block 512.

In block 512, the cloud server 104 receives a user authorization for access. The user authorization indicates that the user associated with the biomatrix authorizes access to the storehouse for the third-party device 106. The user authorization may, for example, identify a particular third-party device 106, third-party organization, third-party individual, or other entity that is granted access to the storehouse. The user authorization may also identify particular documents and/or data in the storehouse for authorization. The user authorization may include one or more time limits, geographical limits, or other policy limits or otherwise specify the specific authorization that is granted. The user authorization process may be interactive, for example using the third-party device 106 and/or a user device 102, or may be specified ahead of time as described above. In block 514, the cloud server 104 determines whether access has been successfully authorized. If not, the method 500 loops back to block 502, in which the cloud server 104 may process additional biomatrix requests. If access is authorized, the method 500 proceeds to block 516.

In block 516, the cloud server 104 may perform one or more storehouse operations. The cloud server 104 may allow access (e.g., read, write, modify, or other access) to secure data storage in the storehouse associated with the biometrically verified user. In some embodiments, in block 518 the cloud server 104 may access a user identity (e.g., one or more names, accounts, or other identity information) associated with the user. In some embodiments, in block 520 the cloud server 104 may allow access to one or more legal documents and/or data such as birth certificate, driver's license or official identification, passport, social security card, legal titles, wills and testaments, and/or other legal documents. In some embodiments, in block 522 the cloud server 104 may allow access to one or more personal or private documents and/or data such as degrees and transcripts, financial records, healthcare records, personal documents, audio, documents, password management, photos, videos, and/or other personal or private documents. After performing storehouse operations, the method 500 loops back to block 502, in which the cloud server 104 may process additional biomatrix requests.

The invention claimed is:

1. A computing device for secure biometric data management, the computing device comprising:
a portal manager to (i) receive a first biomatrix from a client computing device, wherein the first biomatrix comprises data indicative of one or more biometric marker scans associated with a user, (ii) determine a first set of biometric markers from the one or more biometric marker scans, and (iii) verify the first biomatrix using the first set of biometric markers based on a stored biomatrix; and
a storehouse manager to access secure data storage associated with the user in response to verifying the first biomatrix.

2. The computing device of claim 1, wherein to determine the first set of biometric markers comprises to select a random set of the one or more biomarker scans.

3. The computing device of claim 1, wherein to determine the first set of biometric markers comprises to select the first set of biometric markers based on a predetermined security policy.

4. The computing device of claim 1, wherein to determine the first set of biometric markers comprises to determine a number of biometric markers in the first set of biometric markers based on a predetermined security policy.

5. The computing device of claim 1, wherein the one or more biometric marker scans comprises a facial recognition scan, a first retina scan, a second retina scan, a first fingerprint scan, and a second fingerprint scan.

6. The computing device of claim 1, wherein:
the portal manager is further to receive user authorization for access by the client computing device; and
to access the secure data storage comprises to access the secure data storage in response to receipt of the user authorization.

7. The computing device of claim 1, wherein to access the secure data storage comprises to securely store a document in the secure data storage.

8. The computing device of claim 1, wherein to access the secure data storage comprises to generate an authenticated offline copy of a secure document in the secure data storage, wherein the authenticated offline copy comprises a digital watermark indicative of authenticity.

9. The computing device of claim 1, wherein to access the secure data storage comprises to authorize transfer of a secure document in the secure data storage to a third party.

10. The computing device of claim 1, wherein the portal manager is further to identify the user based on the first biomatrix.

11. The computing device of claim 10, wherein to access the secure data storage comprises to access a user identity associated with the user.

12. The computing device of claim 1, further comprising a biomatrix manager to:
verify an identity of the user;
receive captured biometric data indicative of the one or more biometric marker scans associated with the user;
generate the stored biomatrix as a function of the captured biometric data in response to verification of the identity of the user; and
associate the secure data storage with the stored biomatrix.

13. The computing device of claim 1, wherein the secure data storage comprises personal documents, legal documents, or health records associated with the user.

14. The computing device of claim 1, wherein the client computing device comprises a user device or a third-party device.

15. A method for secure biometric data management, the method comprising:
receiving, by a computing device, a first biomatrix from a client computing device, wherein the first biomatrix comprises data indicative of one or more biometric marker scans associated with a user;
determining, by the computing device, a first set of biometric markers from the one or more biometric marker scans;
verifying, by the computing device, the first biomatrix using the first set of biometric markers based on a stored biomatrix; and
accessing, by the computing device, secure data storage associated with the user in response to verifying the first biomatrix.

16. The method of claim 15, wherein determining the first set of biometric markers comprises selecting a random set of the one or more biomarker scans.

17. The method of claim 15, wherein determining the first set of biometric markers comprises selecting the first set of biometric markers based on a predetermined security policy.

18. The method of claim 15, further comprising:
receiving, by the computing device, user authorization for access by the client computing device;
wherein accessing the secure data storage comprises accessing the secure data storage in response to receiving the user authorization.

19. The method of claim 15, further comprising identifying, by the computing device, the user based on the first biomatrix.

20. The method of claim 15, further comprising:
verifying, by the computing device, an identity of the user;
receiving, by the computing device, captured biometric data indicative of the one or more biometric marker scans associated with the user;
generating, by the computing device, the stored biomatrix as a function of the captured biometric data in response to verifying the identity of the user; and
associating, by the computing device, the secure data storage with the stored biomatrix.
